(19) United States
(12) Patent Application Publication
(10) Pub. No.: US 2004/0201650 A1
(43) Pub. Date: Oct. 14, 2004

(54) Pattern formation apparatus and manufacturing method thereof

(76) Inventors: Kaoru Higuchi, Tenri-shi (JP); Hitoshi Isono, Tenri-shi (JP); Tomoyuki Sagara, Sakurai-shi (JP); Chiyoshi Yoshioka, Nara-shi (JP)

Correspondence Address: BIRCH STEWART KOLASCH & BIRCH, PO BOX 747, FALLS CHURCH, VA, 22040-0747, US

(21) Appl. No.: 10/820,113

(22) Filed: Apr. 8, 2004

(30) Foreign Application Priority Data
Apr. 10, 2003 (JP) 2003-106686

(51) Int. Cl. B41J 2/045

(52) U.S. Cl. 347/71

(57) ABSTRACT

In a pattern forming apparatus that forms a pattern by jetting out an ink from nozzle opening sections of nozzles, the nozzles are formed by bonding a top plate to a surface of a substrate on which a concave section is formed, and the substrate is combined with the top plate by melting a combining layer formed on at least one of the substrate and the top plate. With this, the shape accuracy of the nozzle opening sections of the pattern forming apparatus is ensured.

This Nonprovisional application claims priority under 35 U.S.C. § 119(a) on Patent Application No. 2003/106686 filed in Japan on Apr. 10, 2003, the entire contents of which are hereby incorporated by reference.

### FIELD OF THE INVENTION

The present invention relates to a pattern formation apparatus that forms a micropattern with the use of minute dots and to a manufacturing method of the pattern formation apparatus. Especially, the present invention relates to a pattern formation apparatus and a manufacturing method of the pattern formation apparatus that are applicable to (i) a pattern formation for manufacturing a flat display such as a liquid crystal display apparatus, a plasma display, or an organic EL, (ii) to a micro conductive pattern formation of a printed wiring board, or (iii) other pattern formation.

### BACKGROUND OF THE INVENTION

The photolithography method, the printing method, the electrode position process, or other method is used in a conventional pattern formation of a micropattern of a color filter for use in a liquid crystal display apparatus or the like. Among these formation methods, the photolithography method excels at its accuracy and its appearance quality. The photolithography method is also used for carrying out hardwiring with high accuracy when conductive patterns of a printed wiring board are formed.

However, the photolithography method causes the step of forming the conductive patterns or forming the pattern for the color filter to become complicated. Because of this, it was not possible to reduce the manufacturing costs.

In view of the circumstances, a pattern formation apparatus has been recently developed actively that can form a micropattern with high accuracy by directly plotting minute ink dots. Such a pattern formation apparatus can carry out the above pattern formation while curbing the manufacturing costs. For example, according to a patent document (Japanese unexamined patent publication No. 2001-68827 published on Mar. 16, 2001), a method for forming a pattern with the use of a method in which pressurized ink is jetted out via a micro nozzle is proposed. The following description deals with a conventional arrangement of this pattern formation apparatus with reference to FIG. 10.

FIG. 10 is a schematic cross sectional view showing a conventional micro pattern formation apparatus in which the pressurized ink is jetted out via a micro nozzle. In FIG. 10, a micro pattern formation apparatus 21 includes a silicon substrate 22, a supporting member 26 provided on a side of a front surface 22A of the silicon substrate 22, an ink supply section 28 that supplies the ink to an air space between the silicon substrate 22 and the supporting member 26, an ink supply apparatus 29 that is connected to the ink supply section 28. The silicon substrate 22 includes a plurality of micro nozzles 23 each pass completely through the silicon substrate 22 such that the front surface 22A and a rear surface 22B communicate through the micro nozzle 23. An upper opening 23a of the micro nozzle 23 partially constitutes the air space between the silicon substrate 22 and the supporting member 26. Namely, the upper opening 23a is disposed in a same plane of the front surface 22A. The silicon substrate 22 is made of a silicon monocrystal, and has a thickness that falls within a range from 200 μm to 500 μm. This kind of substrate 22 has a small linear expansion coefficient of about 2.6×10⁻⁶/K. This allows the substrate 22 to have a minute shape change even if an ambient temperature changes.

The micro nozzle 23 is defined by an interspace that has a shape of a cylinder solid. More specifically, the micro nozzle 23 has a cross section shape of a circle in a direction perpendicular to a major axis, the cross section being parallel to the front surface 22A of the silicon substrate 22. The micro nozzle 23 has a cross sectional shape of a rectangle in the major axis, the cross section being perpendicular to the front surface 22A of the silicon substrate 22. The micro nozzle 23 has an inner wall on which an SiO₂ layer 24 is provided. In general, such an SiO₂ layer 24 has a thickness that falls within a range from 5000 Å to 10000 Å.

The micro nozzle 23 is appropriately set to have an opening whose diameter falls within a range from 1 μm to 100 μm. The micro nozzle 23 is appropriately set to have an aspect ratio that falls within a range from 1 to 100. It is possible to appropriately set the number of the micro nozzles 23 and the interval between the micro nozzles 23, in accordance with a shape of the pattern to be formed by the pattern formation apparatus 21, the forming method, or the like. The minimum interval is about 1 μm.

Note that the cross sectional shape of the micro nozzle 23 may be an ellipsoid, a polygon, or other specified shape. When the cross sectional shape is an ellipsoid or a polygon, it is possible to appropriately set the diameter of an opening in the major axis to a range from 5 μm to 500 μm.

The supporting member 26 is provided on the side of the front surface 22A of the silicon substrate 22 so as to support the silicon substrate 22. The supporting member 26 includes a base 26a that has a same plan shape as the silicon substrate 22, a flange part 26b provided in a circumferential part of the base 26a, and an opening 26c provided in the center of the base 26a. The supporting member 26 is fixed to a circumferential part on the side of the front surface 22A of the silicon substrate 22 at the flange part 26b. This allows the space, to which the ink is supplied, to be provided between the silicon substrate 22 and the supporting member 26. The supporting member 26 is made of a material having a linear expansion coefficient that falls within a range from one tenth to tenfold of that of the silicon substrate 22. For example, such a material may be pyrex (name of article: Corning #7740) having a linear expansion coefficient of 3.5×10⁻⁶/K, SUS304 having a linear expansion coefficient of 17.3×10⁻⁶/K, or the like.

The ink supply section 28 has an ink flow path that has a pipe shape. One end of the ink supply section 28 is connected to the opening 26c of the supporting member 26, and the other end is connected to the ink supply apparatus 29.

The ink supply apparatus 29 is appropriately selected, in accordance with the intended use of a micro pattern formation apparatus 21, from a continuous supply pump, a fixed quantity supply pump, or the like.

When manufacturing a conventional micro pattern formation apparatus having the above arrangement, an ink flow path and a nozzle have been simultaneously formed with the use of the deep etching such that a nozzle, especially a micro nozzle, is formed on a silicon substrate. However, the shape accuracy of the nozzle thus formed was about ±1 μm.

Unlike a piezoelectric driving method or a bubble jet method in which a jet principle based on the pressure fluctuation under constant volume is used, in cases where the jetting-out is carried out by pressurizing the ink from an ink supply section or by sucking in the ink from outside of the nozzle, it is almost impossible to control, in a driving source, the jetting-out amount. This gives rise to the problem that the shape of the nozzle determining the resistance of the ink flow, especially the diameter of the micro nozzle will adversely affect the jetting-out amount. In this regard, in a micro nozzle, especially in a micro nozzle whose opening area is not more than 50 μm², the ±1 μm fluctuation of the nozzle accuracy has caused the large fluctuation of the jetting-out amount.

For example, when wiring patterns are formed by the above apparatus, the fluctuation of the thickness of the wirings or the fluctuation of the width of the wirings occurs because the jetting-out amount differs from nozzle to nozzle, thereby causing the nonuniformity of the resistances of the wirings. Especially, this kind of problem becomes serious in cases where the opening area of the nozzle is not more than 5 μm². In cases where the jetting-out is carried out by pressurizing the ink from the ink supply section, it is most likely that a nozzle having a large resistance, i.e., a micro nozzle has the defect of jetting-out at worst when the difference of the resistances of the flow paths among the nozzles is large. Further, this causes defective apparatuses having the defect such as no opening of some nozzles to be often produced during the manufacturing process.

On this account, when a color filter is manufactured with the use of the above pattern formation apparatus, the color heterogeneity or the color missing becomes a big problem. When the wiring patterns are manufactured with the use of the above pattern formation apparatus, the nonuniformity of the wiring resistances occurs, and the problem, such as the breaking of wire or the short circuit between the neighboring wires, occurs at worst.

In view of the circumstances, by analogy with a manufacturing method of a recording head in an ink jet recording apparatus disclosed in a patent article 2 (Japanese unexamined patent publication No. 1-125241 published on May 17, 1989) or a patent article 3 (Japanese unexamined patent publication No. 1-228861 published on Sep. 12, 1989), this kind of pattern formation apparatus may adopt an arrangement of forming nozzles and ink flow paths 6, in which (i) concave sections for ink flow paths and nozzles are formed on a base substrate, and (ii) a top plate is bonded to a surface of the base substrate on which the concave sections are formed.

In such an arrangement, the shape accuracy of the nozzle varies depending on the formation accuracy of the concave section on the base substrate. Accordingly, it is possible to form the nozzles with high accuracy by carrying out a fabrication under optimum conditions with the use of the process such as the etching or the photolithography.

The conventional way how to combine the base substrate with the top plate when the nozzles are formed by combining the concave sections on the base substrate with the top plate is disclosed in the patent article 3. According to the patent article 3, an adhesive agent is applied onto the top plate or a bonding surface of the base substrate with the use of the spin coat method or other method, and then the top plate and the concave sections are bonded to each other. However, when the bonding is carried out with the use of the adhesive agent, it is necessary to apply the adhesive agent such that the adhesive agent has a thickness of several μm. This is because the bonding strength should be secured and the sealing between the neighboring nozzles should be secured. In this case, the adhesive agent, thus applied during the bonding of the base substrate and the top plate, flows into the openings of the nozzles. This causes the area of the opening of the nozzle to be slightly reduced by the adhesive agent thus flown into. This causes another problem.

The nozzle produced with the use of the technique disclosed in the patent article 3 has an opening area of about 500 μm². In the case of a nozzle having a shape of a square, such a nozzle has a side of not less than about 20 μm. On this account, even if the surplus adhesive agent flows into the nozzle, no big problem occurs. In contrast, in an apparatus which forms micropattern patterns for the pattern formation of the color filter, the conductive pattern formation, or the like, it is necessary to form micro nozzles having an opening area of not more than 50 μm².

In the micro nozzle having such a small opening area, the flowing of the adhesive agent into the nozzle causes the fluctuation of the opening area of the nozzle to become very large. Namely, the ratio of the fluctuation to the opening area becomes very large. This greatly affects the formation of the micropatterns. More specifically, although it is possible to manufacture the nozzle with high accuracy by fabricating and obtaining the shape of the concave section, it is not possible to solve the problem that the jetting-out amount of the ink can not be controlled with accuracy. This is because the nonuniformity of the opening areas of the nozzles is very large during being used for practical purposes. Especially, when the cross sectional area of the nozzle is not more than 10 μm², the above problem becomes serious, and, at worst, some nozzles may be choked with the adhesive agent such that the jetting-out can not be carried out.

### SUMMARY OF THE INVENTION

An object of the present invention is to provide a pattern formation apparatus and a manufacturing method thereof that can form patterns with high accuracy.

In order to achieve the object, a pattern formation apparatus of the present invention comprises: a substrate including a concave section; a top plate that is combined with a surface of the substrate where the concave section is provided; a combining layer, provided on at least one of the substrate and the top plate, via which the substrate and the top plate are combined with each other, and nozzles formed by melting the combining layer such that the substrate and the top plate are combined with each other, the nozzles jetting out ink such that a pattern is formed.

The combining layer indicates either a thin film provided on the surface of the substrate or on the surface of the top plate, or a surface of the substrate or the top plate, via which the substrate and the top plate are combined with each other. Furthermore, as long as the combining layer is provided where the substrate and the top plate contacts each other, it is unnecessary to form the combining layer on the concave section of the substrate.

The above-described “melting the combining layer such that the substrate and the top plate are combined with each other” indicates that the substrate and the top plate are caused to closely contact each other with the combining layer being molten, so that the substrate and the top plate are combined with each other. Here, “melting” implies a state that two members can be combined with each other by simply causing one member to contact the other member. Thus, “melting” state includes such a case that solid-phase-bonding between combining layers pressed against each other is enabled by softening them with heat or activating them using ion beam. The melting is carried out by, for instance, leaving the layer in a high-temperature atmosphere, projecting laser light to the layer, and projecting ion beam to the layer. The combining is carried out in such a way that, for instance, the substrate and the top plate are superposed to each other and the combining layer is heated, or the substrate and the top plate are pressed against each other after heating the combining layer.

With the above, after forming the substrate and the top plate, the combining layer which is a part of the substrate or the top plate is molten so that the substrate is combined with the top plate. On this account, the substrate and the top plate are directly combined with each other with almost no change in shape. That is to say, it is unnecessary to carry out a process of applying a highly-fluid material such as an adhesive agent to the gap between the substrate and the top plate, and hence it is possible to prevent the shape of the nozzles from deteriorating after the formation of the substrate and the top plate, the deterioration being caused by such a reason that an adhesive agent flows into the openings of the nozzles of the pattern formation apparatus. As such, it is possible to confirm the shape accuracy of the nozzle opening sections of the nozzles of the pattern forming apparatus, so as to realize a pattern formation with high accuracy.

In order to achieve the object, a method of the present invention for manufacturing a pattern formation apparatus comprises the steps of: (i) combining a surface of a substrate where a concave section is provided with a top plate such that nozzles for jetting out ink are formed; and (ii) melting a combining layer, provided on at least one of the substrate and the top plate, such that the substrate and the top plate are combined with each other via the molten combining layer.

According to this method, a combining surface of at least one of the substrate and the top plate, the combining surface facing the substrate or the top plate, is molten, and the substrate and the top plate are caused to closely contact each other with the surface being molten, and consequently the substrate and the top plate are combined with each other by solidifying the surface. Examples of the method of the combining are as follows: the substrate and the top plate are superposed to each other and the combining layer is heated, or the combining surface is molten by heating and then the substrate and the top plate are pressed against each other, and subsequently the combining surface is solidified by adjusting the temperature to room temperatures.

Note that, “melting” implies a state that two members can be combined with each other by simply causing one member to contact the other member, by, for instance, putting the members in a high-temperature atmosphere or softening/activating the members by projecting laser light or ion beam.

With the above, the combining is carried out in such a manner that a part of the substrate or the top plate is molten after the substrate and the top plate are formed. On this account, the substrate and the top plate are directly combined with each other with almost no change in shape. That is to say, it is unnecessary to carry out a process of applying a highly-fluid material such as an adhesive agent to the gap between the substrate and the top plate, and hence it is possible to prevent the shape of the nozzles from deteriorating after the formation of the substrate and the top plate, the deterioration being caused by such a reason that an adhesive agent flows into the openings of the nozzles. As such, it is possible to confirm the shape accuracy of the nozzle opening sections of the nozzles of the pattern forming apparatus, so as to realize a pattern formation with high accuracy.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a perspective view showing a pattern formation apparatus of an embodiment in accordance with the present invention.

FIG. 2 is a perspective view showing another pattern formation apparatus of an embodiment in accordance with the present invention.

FIG. 3(a) through FIG. 3(c) are cross sectional views respectively showing manufacturing steps of a pattern formation apparatus of an embodiment in accordance with the present invention.

FIG. 4 is a perspective view showing a pattern formation apparatus of another embodiment in accordance with the present invention.

FIG. 5(a) and FIG. 5(b) are perspective views respectively showing a pattern formation apparatus of a further embodiment in accordance with the present invention.

FIG. 6(a) through FIG. 6(e) are cross sectional views respectively showing manufacturing steps of a pattern formation apparatus of still a further embodiment in accordance with the present invention.

FIG. 7(a) through FIG. 7(c) are cross sectional views respectively showing manufacturing steps of a pattern formation apparatus of yet another embodiment in accordance with the present invention.

FIG. 8(a) and FIG. 8(b) are cross sectional views respectively showing manufacturing steps of a pattern formation apparatus of yet a further embodiment in accordance with the present invention.

FIG. 9(a) and FIG. 9(b) are cross sectional views respectively showing manufacturing steps of a pattern formation apparatus of yet a further embodiment in accordance with the present invention.

FIG. 10 is a cross sectional view showing a conventional pattern formation apparatus.

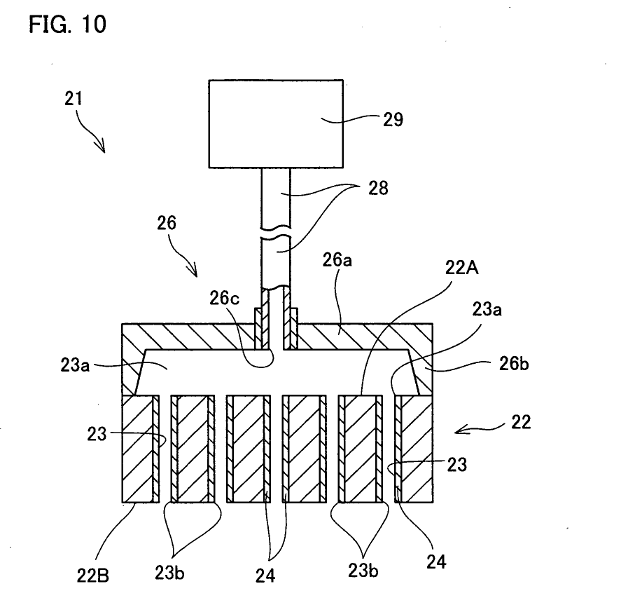

### DESCRIPTION OF THE EMBODIMENTS

[First Embodiment]

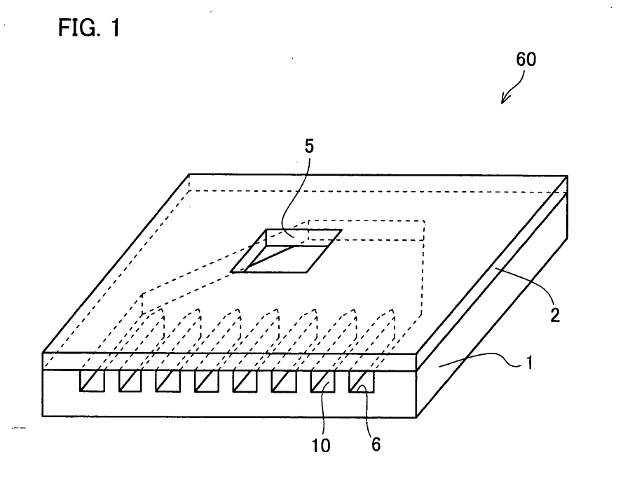

The following description deals with the first embodiment of the present invention with reference to FIG. 1 through FIG. 3.

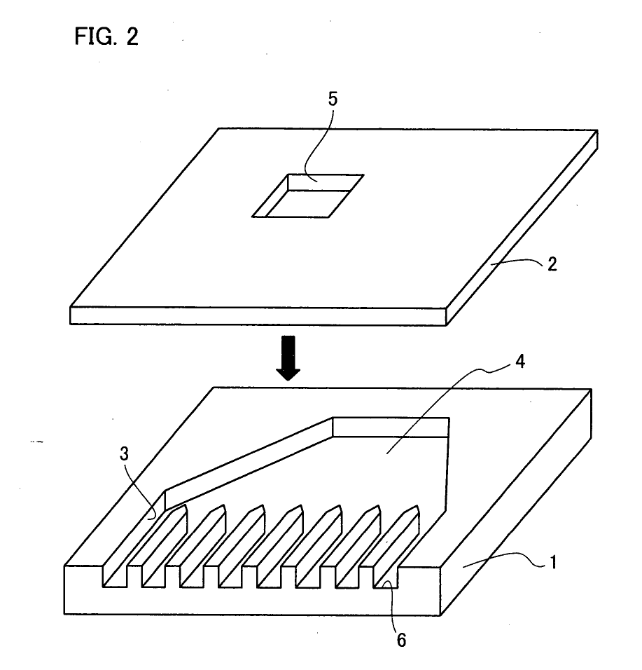

FIG. 1 is a perspective view showing an embodiment of a pattern formation apparatus 60 in accordance with the present invention. FIG. 2 is a perspective view showing components of the pattern formation apparatus 60 that have not yet been fabricated.

The pattern formation apparatus 60 shown in FIG. 1 is realized by combining a base substrate (substrate) 1 and a top plate 2. The pattern formation apparatus 60 jets out the ink in accordance with the need so as to form patterns. As shown in FIG. 2, a surface of the base substrate 1 with which the top plate 2 is combined includes a concave section in which an ink common chamber 4 that holds the ink is formed, and ink flow paths 3, formed in a canaliform manner, each constituting a nozzle 10 and communicating the ink common chamber 4 and from each surface (jetting-out surface) the ink is jetted out. An opening in the jetting-out surface of the ink flow path 3 corresponds to a nozzle opening section 6. The combining of the base substrate 1 with the top plate 2 allows the ink common chamber 4 to hold the ink. The ink flow path 3 becomes the nozzle 10 that jets out the ink. The top plate 2 includes an ink supply opening 5 with which an ink supply apparatus (not shown) and the ink common chamber 4 communicate such that the ink is supplied to the ink common chamber 4. The ink common chamber 4 accumulates the ink supplied by the ink supply apparatus, and the ink thus accumulated is jetted out in accordance with the need, via the ink flow paths 3 and the nozzle opening sections 6.

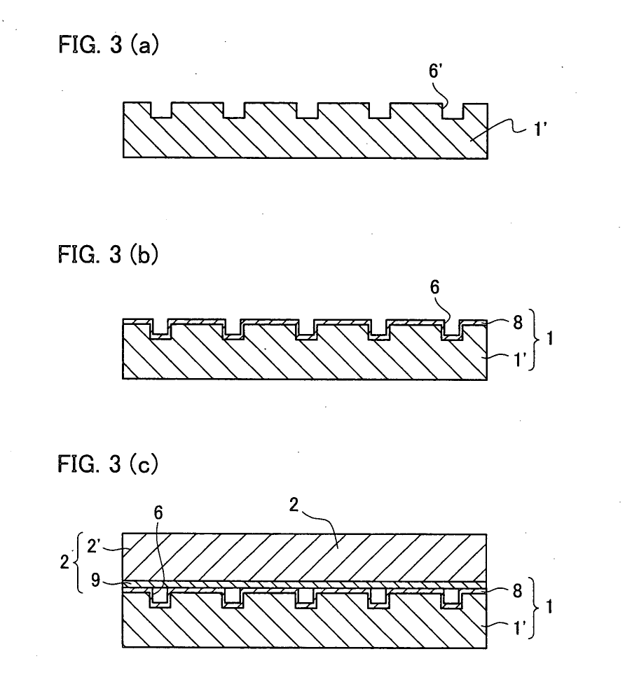

The following description deals with a manufacturing method of the pattern formation apparatus 60 with reference to FIG. 3. FIG. 3 is a cross sectional view showing the vicinity of the jetting-out surface of the pattern formation apparatus 60.

First, the description will be made as to how the base substrate 1 is manufactured. Formed on a flat plate 1′ are concave sections for forming the ink flow paths 3 and the ink common chamber 4, and then the flat plate 1′ is coated with an Au thin film 8. Thus, the base substrate 1 is manufactured. A flat plate made of monocrystal silicon having a thickness of 500 μm is used as the flat plate 1′. It was designed such that concave sections 6′ for forming the nozzle opening sections 6 had a width of 3 μm and a depth of 3 μm.

The concave sections are manufactured as follows. A photosensitive resist is applied onto one surface of the flat plate 1′, and exposure and development are carried out via a predetermined photomask, thereby forming a resist pattern. Using the resist pattern as a mask, the dry etching is carried out such that (i) a concave section for forming the ink common chamber 4 and (ii) the concave sections 6′ for forming the ink flow paths 3 and the nozzle opening sections 6 are formed on the flat plate 1′ (see FIG. 3(a)). The ink flow paths 3 are etched so as to have a similar shape to the concave sections 6′, and so as to extend smooth toward the ink common chamber 4 at the joint with the ink common chamber 4.

Note that the arrangement of the ink flow paths 3 and the concave sections 6′ will be appropriately set in accordance with the a pattern to be formed. Especially, when the jetting-out is carried out in accordance with the pressure method, it is desirable to design the flow path resistances of the nozzles and the ink flow paths such that the respective nozzles have substantially a same flow path resistance.

The following description deals with a step of combining the top plate 2 with the flat plate 1′ including the concave sections 6′ and the ink flow paths 3.

The Au thin film 8 (combining layer) having a thickness of 0.1 μm is formed by the sputtering method on the surface of the flat plate 1′ where the concave sections 6′ are formed, thereby obtaining the base substrate 1 (see FIG. 3(b)). This allows the concave sections 6 coated with the AU thin film 8 to be formed in the concave sections 6′. Then, an Au thin film 9 (combining layer) having a thickness of 0.1 μm is provided in by the sputtering on the flat plate 2′ that is made of a monocrystal silicon and has a thickness of 500 μm, thereby obtaining the top plate 2. The positioning and the crimping are carried out with respect to the Au thin film 8 of the base substrate 1 and the Au thin film 9 of the top plate 2, under ambient atmosphere of 400 degrees centigrade for one second. This allows the Au thin films 8 and 9 to be molten. Thereafter, when changing the temperature from 400 degrees centigrade to a room temperature, the Au thin films 8 and 9 are combined with each other (see FIG. 3(c)).

In a manufacturing method of the nozzle opening sections 6 and the ink flow paths 3 in accordance with the present invention, the Au thin films 8 and 9 at the combined section is much shallower than the depth of the nozzle opening sections 6. This allows the base substrate 1 and the top plate 2 to be combined with each other without deteriorating the shape accuracy of the nozzle opening sections 6.

In a surface (a combining surface) via which the base substrate 1 and the top plate 2 are combined with each other, it is desirable that (i) a front surface of the ink flow paths 3 and (ii) an area of the top plate 2 where the nozzles 10 are formed have such a relative roughness that does not affect the jetting-out of the ink. More specifically, it is desirable that a maximum surface relative roughness (Rmax) is suppressed to be not more than 0.1. Note that the surface relative roughness of the combining surface is measured by a laser microscope and is compliant with JIS B 0601.

The surface relative roughness that does not affect the jetting-out of the ink makes it possible to carry out a good combining of the base substrate 1 and the top plate 2 combining surface by heat treatment. Namely, when the maximum surface relative roughness (Rmax) is suppressed to be not more than 0.1, it is possible to obtain an apparatus having enough rigidity. In other words, it is possible to form nozzles with high accuracy.

Especially, (i) in a method in which the ink supplied from an ink supply section is pressurized and then is jetted out, or (ii) in a method in which the ink supplied from outside of the nozzle is sucked in and then is jetted out, less rigidity is required for the ink flow paths 3 and the nozzle opening sections 6 than the bubble jet method and other piezoelectric driving methods, provided that they have the rigidity of the nozzle opening sections of a pattern formation apparatus obtained by the foregoing manufacturing method. Thus, since manufacturing conditions for an available pattern formation apparatus are not limited to specific ones, it is possible to manufacture it with ease.

Further, in the manufacturing method, the base substrate 1 and the top plate 2 have the Au thin films 8 and 9, respectively, and the Au thin films 8 and 9 are molten by the heat treatment and combined with each other. The present invention is not limited to this. For example, ultrasonic wave may be applied together with the heat treatment during the combining. In this case, it is possible to carry out the good combining of the base substrate 1 and the top plate 2 under ambient atmosphere of 100 degrees centigrade for one second, thereby ensuring to obtain the combining with reasonable strength.

It is preferable that the metal thin films via which the base substrate 1 and the top plate 2 are made of Au, respectively. However, the present invention is not limited to this. For example, one of the metal thin films may be made of other metal such as Al or Sn. In this case, note that higher heat temperature is required for the combining than that of the combining of the Au thin films. Note also that the material of the base substrate 1 to be used should be heat-resistant, or such a jetting-out that does not burden the pattern formation apparatus during the jetting-out should be adopted, because the combining strength is slightly reduced. Especially, note that the ultrasonic wave should be applied together with the heat treatment during the combining in the case of using the Al thin film.

In the pattern formation apparatus 60 thus manufactured, the ink is pressure-fed by an ink pressure-fed apparatus (not shown), in accordance with a desired target data for the jetting-out. The ink thus pressure-fed is directed to the nozzle opening sections 6, via the ink supply opening 5, the ink common chamber 4, and the ink flow paths 3, respectively, and is jetted out by the nozzle opening sections 6, thereby forming the pattern.

The following description deals with how the foregoing pattern formation apparatus forms the micropattern.

A glass substrate having a thickness of 0.7 mm was used as a recording medium on which a pattern is recorded. The glass substrate was subjected to preliminary washing. The ink was supplied to the ink supply apparatus in advance. The glass substrate was provided so as to face the jetting-out surface of the pattern formation apparatus. The ink was jetted out from the pattern formation apparatus 60 such that a striped pattern was drawn, while scanning the glass substrate at a constant speed of 1 inch/sec in a direction of an in-plane direction of the glass substrate, the direction being perpendicular to a direction in which the nozzles are aligned. During the drawing, the ink was supplied from the ink supply apparatus, and was jetted out from the respective nozzle opening sections 6. Then, the pattern drawn by the ink was dried and was formed as a desired target pattern.

In accordance with a similar method to the above method, 50 ink flow paths and nozzle opening sections 6, each having 5-μm-square openings (an opening area of 25 μm²) or 7-μm-square (an opening area of 49 μm²), were formed other than 3-μm-square as alternative shapes of the nozzle opening section 6. The shape accuracy was confirmed with respect to the nozzle opening sections 6. According to the confirmation of the shape accuracy, the shape accuracy of any one of the nozzle opening sections 6 was very high and it was possible to form a pattern having an nonuniformity of not more than ±0.2 μm. This was because an aspect ratio of the depth of the nozzle opening section 6 and the thickness of the Au thin films 8 and 9 at the combined section were great enough. Such a nonuniformity of not more than ±0.2 μm corresponds to a nonuniformity of not more than 1/10 in terms of the dimension of the nozzle, and corresponds to a nonuniformity of not more than 1/100 in terms of the cross sectional area of the nozzle. Each nonuniformity is negligible in terms of the nonuniformity of the jetting-out amount of the respective nozzles.

Thus, according to the pattern formation apparatus formed by the manufacturing method of the present embodiment, it is possible for the shape accuracy to fall within such a level that does not affect the jetting-out performance. Furthermore, it is possible to form nozzle opening sections with high accuracy, by appropriately managing the shape accuracy of the photomask during the forming of the concave sections 6′ in the manufacturing method.

Note that, in the present embodiment, the preliminary washing was carried out with respect to the glass substrate (recording medium to be recorded) only before the pattern formation. The present invention is not limited to this. A pretreatment or a coating treatment, which ensures an appropriate affinity with respect to the ink to be used, allows a pattern to be formed which has a line width of finer and of less nonuniformity.

[Second Embodiment]

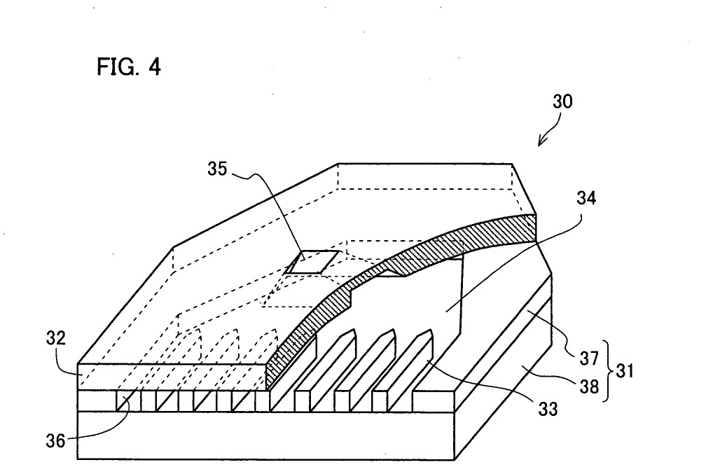

The following description deals with another embodiment of the present invention with reference to FIG. 4. Note that, for convenience, the same reference numerals and symbols are assigned to the members that have the same functions as those of the first embodiment, and the descriptions thereof are omitted here.

FIG. 4 is a perspective view showing another embodiment of a pattern formation apparatus in accordance with the present invention. In FIG. 4, a pattern formation apparatus 30 is realized by combining a base substrate 31 with a top plate 32. The pattern formation apparatus 30 forms a pattern by jetting out the ink in accordance with the need. The base substrate 31 includes an SiO₂ layer 37 on a surface (combining surface) via which the top plate 32 and the base substrate 31 are combined with each other. The SiO₂ layer 37 is etched such that (i) an concave section for forming an ink common chamber 34 that holds the ink, and (ii) a plurality of ink flow paths 33 are formed in a canaliform manner, each communicating the ink common chamber 34 and from each surface (jetting-out surface) the ink being jetted out. An opening in the jetting-out surface of the ink flow path 33 corresponds to a nozzle opening section 36.

The top plate 32 includes an ink supply opening 35 with which an ink supply apparatus (not shown) and the ink common chamber 34 communicate such that the ink is supplied to the ink common chamber 34. The ink supply opening 35 is formed such that an opening area is greater toward the ink common chamber 34. The ink common chamber 34 accumulates the ink supplied by the ink supply apparatus, and the ink thus accumulated is jetted out in accordance with the need, via the ink flow paths 33.

The following description deals with a method of manufacturing the pattern formation apparatus 30. First, the description will be made as to how the base substrate 31 is manufactured. An SiO₂ layer 37 was formed on a flat plate 38. A concave section was formed in the SiO₂ layer 37. The SiO₂ layer 37 was etched such that the ink flow paths 33 and the ink common chamber 34 were formed in the concave section. Thus, the base substrate 31 was manufactured.

A monocrystal silicon having a thickness of 500 μm was used as the flat plate 38. The SiO₂ layer 37 having a width of 3 μm was formed on the flat plate 38. Then, a photosensitive resist was applied onto a surface of the SiO₂ layer 37, and was exposed and developed via a predetermined photomask, thereby forming a resist pattern. Using the resist pattern as a mask, the dry etching is carried out such that (i) the concave section for forming the ink common chamber 34 in the SiO₂ layer 37, and (ii) the concave sections for forming the ink flow paths 33 and nozzle opening sections 36 were formed.

Each of the concave sections for forming the nozzle opening sections 36 was etched so as to have a width of 3 μm and a depth of 3 μm. Each of the ink flow paths 33 was etched so as to have a similar shape to that of the nozzle opening section 36. This allows the ink flow paths 33 to extend smooth toward the ink common chamber 34 at the joint with the ink common chamber 34. With respect to the SiO₂ layer 37, the etching is carried out up to the surface of the flat plate 38, by making (i) the depth of the concave section that forms the nozzle opening sections 36 and (ii) the depth of the ink flow path 33 equal to the thickness of the SiO₂ layer 37. This permits improving in the dimensional accuracy of the respective nozzle opening sections 36. Note that (i) the depth of the concave section that forms the nozzle opening sections 36 and (ii) the depth of the ink flow path 33 may be shallower or deeper than the thickness of the SiO₂ layer 37.

It is possible to manufacture the pattern formation apparatus 30, by combining the top plate 32 having an ink supply opening 35 with the etched surface of the base substrate 31 manufactured as described above. The way to combine them is similar to that of the first embodiment.

In the pattern formation apparatus 30 thus manufactured, the ink is pressure-fed by an ink pressure-fed apparatus (not shown), in accordance with a desired target data for the jetting-out. The ink thus pressure-fed is directed to the nozzle opening sections 36, via the ink supply opening 35, the ink common chamber 34, and the ink flow paths 33, respectively, and is jetted out by the nozzle opening sections 36, thereby forming the pattern.

(Third Embodiment)

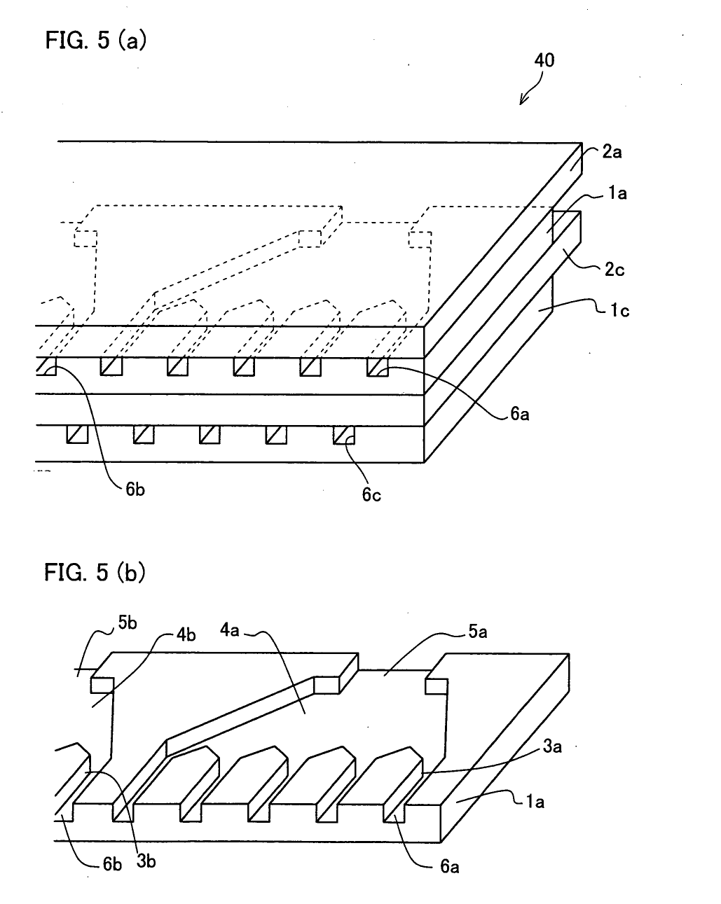

The following description deals with a further embodiment in accordance with the present invention with reference to FIG. 5.

FIG. 5(a) is a perspective view showing such a further embodiment in accordance with a pattern formation apparatus of the present invention. The pattern formation apparatus of the present embodiment exemplifies an arrangement in which nozzles are provided in a double-decker manner, thereby obtaining multiple-nozzle structure and high-density of the nozzles. The following description deals with a pattern formation apparatus 40 with the multiple-nozzle structure and the high-density of the nozzles with reference to FIG. 5(a).

In FIG. 5(a), a first base substrate 1c, a first top plate 2c, a second base substrate 1a, and a second top plate 2a are combined in this order, thereby obtaining the pattern formation apparatus 40. The pattern formation apparatus 40 forms a pattern by jetting out the ink in accordance with the need. FIG. 5(b) shows the second top plate 2a that has not yet combined.

With the arrangement, a surface of the base substrate 1a with which the top plate 2a is combined includes (i) a concave section in which an ink common chamber 4a that holds the ink is formed, (ii) a plurality of ink flow paths 3a, formed in a canaliform manner, each being integral with the ink common chamber 4a and each surface (jetting-out surface), from which the ink is jetted out, communicating with the ink common chamber 4a, and (iii) an ink supply opening 5a via which the ink is supplied to the ink common chamber 4a. An opening section in the jetting-out surface of the ink flow path 3a corresponds to the nozzle opening section 6a. The ink, supplied from the ink supply apparatus via the ink supply opening 5a, is accumulated in the ink common chamber 4a, and is jetted out via the ink flow paths 3a in accordance with the need.

The ink common chamber 4a, the ink flow paths 3a, the ink supply opening 5a, and concave sections having similar shapes to those of the nozzle opening sections 6a are independently provided in another region of the surface combining the base substrate 1a with the top plate 2a such that the nozzle opening sections are aligned in a line. Such concave sections correspond to the ink common chamber 4b, the ink flow paths 3b, and the nozzle opening sections 6b shown in FIG. 5, respectively. In the base substrate 1c, a surface combining the base substrate 1c and the top plate 2c is etched so as to have a similar shape to that of the base substrate 1a.

The base substrates 1a and 1c are combined with the top plates 2a and 2c in a similar method to the first embodiment. The base substrate 1a and the top plate 2c are provided such that the nozzle opening sections 6a and 6c are disposed in a staggered manner in the jetting-out surfaces of the base substrates 1a and 1c. In other words, the base substrate 1a and the top plate 2c are provided such that each of the nozzle opening sections 6c is disposed at the center of the neighboring two nozzle opening sections 6a, in a direction perpendicular to the combining surface (see FIG. 5(a)).

Like the present arrangement, by independently providing the ink common chambers 4a and 4b, (i) it is possible to suppress the nonuniformity of distances between the ink supply openings 5a and 5b and the nozzle opening sections 6a and 6c, and (ii) it is possible to shorten the paths from the ink supply openings 5a and 5b to the ink flow paths 3a and 3b via the ink common chambers 4a and 4b. This permits wholly reducing of the path resistance of the ink. Further, by providing the ink supply openings 5a and 5b in the base substrate and by forming the ink supply openings 5a and 5b integral with the ink flow paths 3a and 3b, (i) it is possible to reduce a step as compared with cases where ink supply openings are provided in a separate step, and (ii) it is possible to omit the positioning of the top plate and the base substrate. This permits improving in process yield and the like.

(Fourth Embodiment)

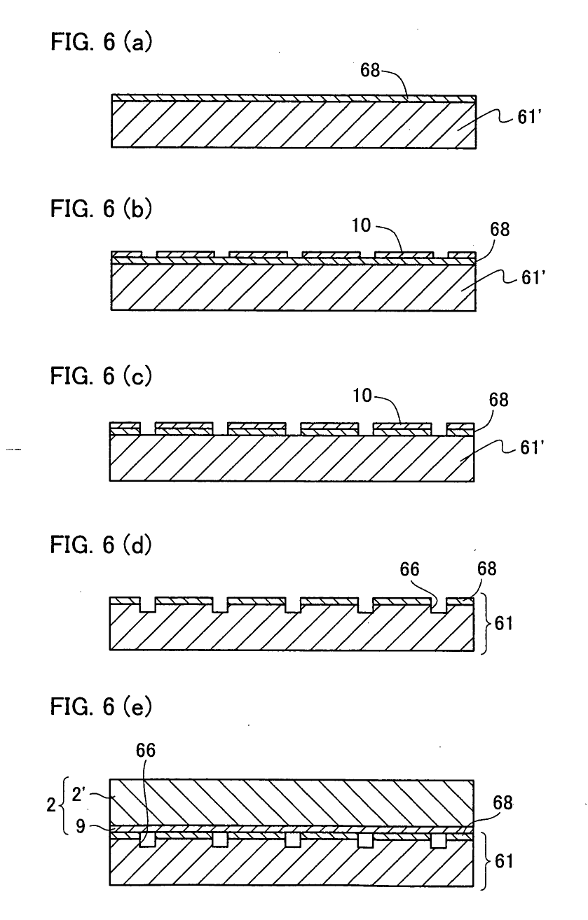

The following description deals with still another embodiment of the present invention with reference to FIG. 6. Note that, for convenience, the same reference numerals and symbols are assigned to the members that have the same functions as those of the foregoing embodiment, and the descriptions thereof are omitted here.

The present embodiment presents another method of manufacturing the base substrate 1 of the first embodiment. More specifically, the present embodiment presents a method for forming the concave section after forming the metal thin film on the flat plate, during forming of the base substrate.

FIG. 6 shows (i) a step in which nozzles and ink flow paths are formed on a flat plate such that a base substrate 61 is manufactured, and (ii) a step of combining the base substrate 61 with a top plate 62.

First, as shown in FIG. 6(a), an Au thin film 68 having a thickness of 0.1 μm is deposited on a flat plate 61′ made of monocrystal silicon having a thickness of 500 μm. The Au thin film 68 on the flat plate 61′ is coated with a photosensitive resist, and is exposed and developed via a predetermined photomask, thereby forming a resist pattern 10 (see FIG. 6(b)). Then, using the resist pattern 10 as a mask, the dry etching is carried out such that a patterning is carried out with respect to the Au thin film 68 (see FIG. 6(c)). Thereafter, the resist pattern 10 is removed, and then, using the patterned Au thin film 68 as a mask, the dry etching is carried out such that concave sections 66 for forming the nozzle opening sections each having a width of 3 μm and a depth of 3 μm are formed on the flat plate 61′, thereby obtaining the base substrate 61 (see FIG. 6(d)). Subsequently, an Au thin film 9 having a thickness of 0.1 μm is sputtered on a surface, to be combined with the base substrate 61, of a flat plate 62′ made of monocrystal silicon having a thickness of 500 μm, thereby obtaining a top plate 2. The top plate 2 and the base substrate 61 are pressurized while carrying out the positioning, are kept under an ambient temperature of 100 degrees centigrade for one second, and are subjected to a supersonic wave, so as to be combined with each other (see FIG. 6(e)).

According to the method for manufacturing the concave sections 66 for forming the nozzle opening sections in accordance with the present embodiment, the shape accuracy of the nozzle opening sections 66 will never deteriorate. This is because the concave sections 66 for forming the nozzle opening sections are formed after forming the Au thin film 68 of the base substrate 61. As such, it is possible to improve in the shape accuracy of the nozzle opening sections 66. Further, when the Au thin film 68 is formed on the flat plate 61′, it is possible to carry out the formation of the thin film on the flat plate 61′ having no concave and convex. As such, it is possible to improve the thickness accuracy of the Au thin film 68. In accordance with a similar method to the above method, 50 ink flow paths and nozzle opening sections, each having 5-μm-square openings (an opening area of 25 μm²) or 7-μm-square (an opening area of 49 μm²), were formed other than 3-μm-square as alternative shapes of the nozzle opening section. The shape accuracy was confirmed with respect to the nozzle opening sections. According to the confirmation of the shape accuracy, the shape accuracy of any one of the nozzle opening sections was very high and it was possible to form a pattern having an nonuniformity of not more than ±0.2 μm. This was because an aspect ratio of the depth of concave section 66 for forming the nozzle opening sections and the thickness of the Au thin films 68 and 9 at the combined section were great enough. Such a nonuniformity of not more than ±0.2 μm corresponds to a nonuniformity of not more than 1/10 in terms of the dimension of the nozzle, and corresponds to a nonuniformity of not more than 1/100 in terms of the cross sectional area of the nozzle. Each nonuniformity is negligible in terms of the nonuniformity of the jetting-out amount of the respective nozzles.

Thus, according to the pattern formation apparatus formed by the manufacturing method of the present embodiment, it is possible for the shape accuracy to fall within such a level that does not affect the jetting-out performance. Furthermore, it is possible to form nozzle opening sections with high accuracy, by appropriately managing the shape accuracy of the photomask during the forming of the concave sections 66 in the manufacturing method.

(Fifth Embodiment)

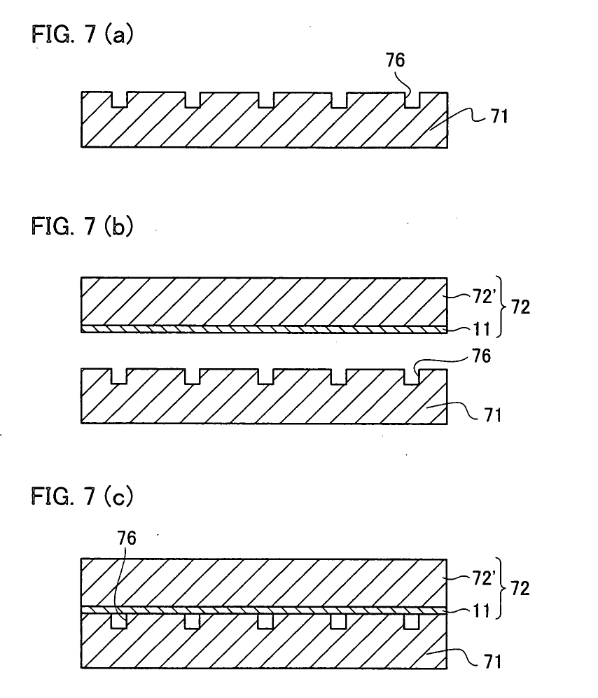

The following description deals with still a further embodiment of the present invention with reference to FIG. 7. Note that, for convenience, the same reference numerals and symbols are assigned to the members that have the same functions as those of the foregoing embodiment, and the descriptions thereof are omitted here.

The present embodiment presents a further method in which (i) a base substrate 71 prepared in a similar manner to the flat plate 1′ of the first embodiment and (ii) a top plate 72 having a similar shape to the flat plate 2′ are combined with each other.

FIG. 7 shows a step in which the base substrate 71 including nozzles and ink flow paths and the top plate 72 are combined with each other. The following description deals with the way how to combine the base substrate 71 with the top plate 72 with reference to FIG. 7.

First, concave sections 76, in which nozzle opening sections each having a width of 7 μm and a depth of 7 μm are formed, are provided on a flat plate made of Al₂O₃ having a thickness of 300 μm, thereby obtaining the base substrate 71. Like the first embodiment, the concave sections 76 are formed by the etching with a photosensitive resist being used as a mask (see FIG. 7(a)). An SiO₂ layer 11 of application-type having a thickness of 1 μm is formed by the spin coating on the top plate 72′ made of a monocrystal silicon having a thickness of 500 μm, thereby obtaining the top plate 72 (see FIG. 7(b)). Then, the top plate 72 is mounted on the base substrate 71 while carrying out the positioning such that the SiO₂ layer 11 overlap with a surface where nozzle opening sections 76 of the base substrate 71 is formed, and the top plate 72 is combined with the base substrate 71 by baking (see FIG. 7(c)).

In the method for manufacturing the ink flow paths and the micro nozzles in accordance with the present embodiment, the thickness of the SiO₂ layer 11 at the combined section is not more than 0.1 μm after the baking, which is much thinner than the depth of the concave section 76 for forming the nozzle opening sections. This allows the top plate 72 to be combined with the base substrate 71 without deteriorating the shape accuracy of the nozzle opening sections.

Here, an attention should be paid to (i) pressurizing and combining conditions during combining the base substrate 71 with the top plate 72, (ii) material property (viscosity among others) of the SiO₂ layer 11 of application-type. This is because the SiO₂ layer 11 may flow into the nozzle opening sections 76 when positioning and combining the base substrate 71 with the top plate 72. In the present embodiment, the pressure to be applied was set as low as possible and the viscosity of the SiO₂ layer 11 was set as great as possible within such a range that permits uniform applying with the use of the spin coat method.

Although the provision of a clearance groove for the SiO₂ layer 11 in a region where no affection reaches the concave section can prevent the SiO₂ layer 11 from flowing into the nozzle opening sections 76, it is highly likely that the nonuniformity of the application thickness occurs when the spin coat method is used for forming the SiO₂ layer 11. As such, it is necessary to form the SiO₂ layer 11 with the use of another method such as the transfer method.

(Sixth Embodiment)

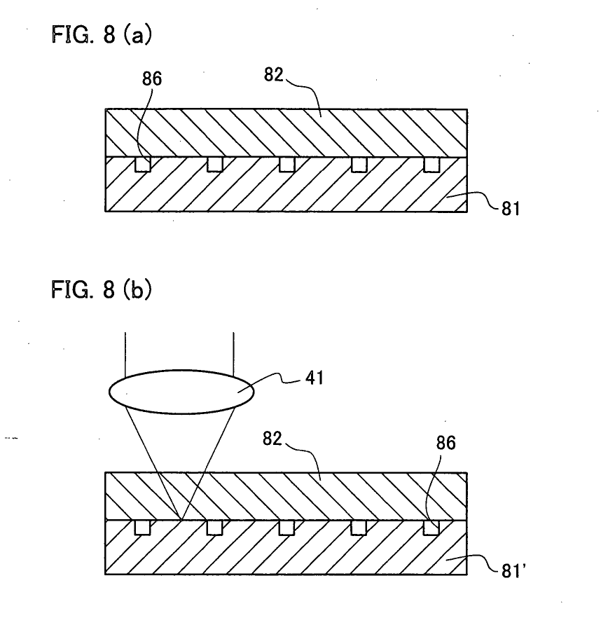

The following description deals with yet another embodiment of the present invention with reference to FIG. 8. Note that, for convenience, the same reference numerals and symbols are assigned to the members that have the same functions as those of the foregoing embodiment, and the descriptions thereof are omitted here.

The present embodiment presents still a further method in which (i) a base substrate 81 prepared in a similar manner to the flat plate 1′ of the first embodiment and (ii) a top plate 82 having a similar shape to the flat plate 2′ are combined with each other.

FIG. 8 shows a step in which (i) the base substrate 81 including concave sections for forming nozzles and ink flow paths, and (ii) the top plate 82 are combined with each other. The following description deals with the way how to combine the base substrate 81 with the top plate 82 with reference to FIG. 8.

First, concave sections 86, in which nozzle opening sections each having a width of 1 μm and a depth of 1 μm are formed, are provided on a flat plate made of monocrystal silicon having a thickness of 500 μm, with the use of the dry etching in which a photosensitive resist is used as a mask. Low-melting glass having a melting point of about 600 degrees centigrade and having a thickness of 200 μm is used as the top plate 82, the low-melting glass including an ink supply opening. The top plate 82 and the base substrate 81 are positioned and are overlapped with each other (see FIG. 8(a)). Then, a laser projector 41 projects laser light, in a region where the nozzle opening sections 86 have no affection, toward a surface (combining surface) via which the top plate 82 and the base substrate 81 are combined. In other words, the laser light is projected only to a region of the combining surface where no nozzle opening section 86 is provided, such a region corresponding to a region via which the base substrate 81 and the top plate 82 make contact with each other. Because of this, the above region in the top plate 82 is molten such that the top plate 82 is combined with the base substrate 81 (see FIG. 8(b.

In the method for manufacturing the ink flow paths and the micro nozzles in accordance with the present embodiment, the combining of the top plate 82 with the base substrate 81 is carried out by the melting of the low-melting glass. This allows the top plate 82 to be combined with the base substrate 81 without deteriorating the shape accuracy of the nozzle opening sections 86. Note that it is preferable that the thickness of the top plate 82 is set as thin as possible in terms of heat loss during the melting, and it is more preferable that the top plate 82 has a thickness of not more than 100 μm. Note also that it is necessary to select a jetting-out method that does not require great stiffness when reducing the thickness of the top plate 82. This is because it is likely that the stiffness is reduced when reducing the thickness of the top plate 82.

It is preferable that the base substrate 81 is made of a material having a high heat resistance. It is preferable that the top plate 82 is made of a lower-melting glass material such as low-melting glass or glass used for molding.

(Seventh Embodiment)

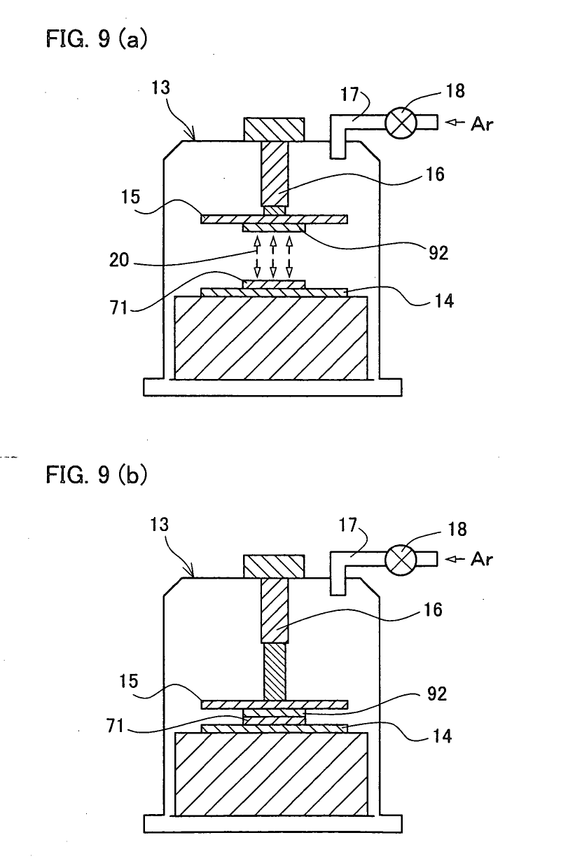

The following description deals with yet a further embodiment of the present invention with reference to FIG. 9. Note that, for convenience, the same reference numerals and symbols are assigned to the members that have the same functions as those of the foregoing embodiment, and the descriptions thereof are omitted here.

The present embodiment presents yet another method in which a base substrate 71 and a top plate 92 are combined with each other.

FIG. 9 shows a step in which (i) the base substrate 71 including concave sections for forming nozzles and ink flow paths, and (ii) the top plate 92 are combined with each other. The following description deals with the way how to combine the base substrate 71 with the top plate 92 with reference to FIG. 9.

The base substrate 71 is made of Al₂O₃ having a thickness of 300 μm, and includes concave sections (not shown), in which the nozzle opening sections and the ink flow paths are formed, have been preliminarily provided. The base substrate 71 is mounted on a lower substrate supporting table 14 in a vacuum chamber 13. The top plate 92 made of Al₂O₃ having a thickness of 300 μm is mounted on an upper substrate supporting table 15. Then, the vacuum chamber 13 is drawn a vacuum up to 1×10⁻⁷ torr to 1×10⁻⁸ torr. Under such a vacuum, a duct valve 18 is opened such that argon gas is introduced into the vacuum chamber 13 via an air duct 17. When the density of the argon gas reaches a predetermined density in the vacuum chamber 13, argon ion beam 20 is projected to a surface (combining surface) via which the base substrate 71 and the top plate 92 are combined with each other so as to activate the combining surface (see FIG. 9(a)).

Immediately after the activation of the combining surface, an arm 16 of the upper substrate supporting table 15 is elongated such that the top plate 92 is pressurized and combined with the base substrate 71 on the lower substrate supporting table 14. This allows the top plate 92 to be combined with the base substrate 71 (see FIG. 9(b)).

In the method for manufacturing the ink flow paths and the micro nozzles in accordance with the present embodiment, since the combining of the top plate 92 with the base substrate 71 is carried out only by the activation of the combining surface, no other member exists at a combining part than the top plate 92 and the base substrate 71. This allows the top plate 92 to be combined with the base substrate 71 without deteriorating the shape accuracy of the nozzle opening sections. Accordingly, it is possible to form the nozzles with high accuracy without any clogging in the nozzle opening sections, especially when the opening area of the nozzle opening section is such a small that is not more than 10 μm².

In accordance with the above method, 50 nozzles, each having 1-μm-square openings (an opening area of 1 μm²) or 3-μm-square (an opening area of 9 μm²), were formed. The shape accuracy was confirmed with respect to the nozzle opening sections. According to the confirmation of the shape accuracy, the shape accuracy of any one of the nozzle opening sections was very high and it was possible to form a pattern having an nonuniformity of not more than ±0.1 μm. Such a nonuniformity of not more than ±0.1 μm corresponds to a nonuniformity of not more than 1/10 in terms of the dimension of the nozzle, and corresponds to a nonuniformity of not more than 1/100 in terms of the cross sectional area of the nozzle. Each nonuniformity is negligible in terms of the nonuniformity of the jetting-out amount of the respective nozzles.

Like the embodiment, when the base substrate 71 is combined with the top plate 92, the nozzles are formed with such a high accuracy as to obtain the uniform nozzles without affecting the jetting-out performance. As such, it is possible to realize a pattern formation apparatus which can carry out a pattern formation with high accuracy.

When, in at least one of the base substrate 71 and the top plate 92, a metal thin film is provided on the surface via which the base substrate 71 and the top plate 92 are combined with each other, the projection of the ion beam allows the base substrate 71 and the top plate 92 to be solid-phase-bonded (eutectic-bonded, diffusion bonded). As such, it is possible to carry out the combining of the base substrate 71 with the top plate 92 in a lower temperature than the melting point, thereby permitting of combining of the base substrate 71 with the top plate 92 with less affecting the shape of the nozzle.

If a wiring pattern of a liquid crystal display apparatus is formed by the above pattern formation apparatus, it is possible to form a minute pattern (i) having uniform wiring width and wiring thickness, and (ii) having a coequal wiring resistance, because the respective nozzles have coequal jetting-out amount. On this account, when a color filter is manufactured with the use of the above pattern formation apparatus, the color missing or other problem does not occur. As such, it is possible to form a pattern having a small color heterogeneity.

Note that the present invention is not limited to the foregoing respective embodiments, and that various modifications can be made within the scope of the claims. Note also that an embodiment, obtained by appropriately combining plural technical means respectively disclosed in different embodiments, is included within a technical scope of the present invention.

In the embodiments above, the combinations of materials of the top plate and the base substrate are not limited to any particular ones. It is preferable, however, that the linear expansion coefficient of the top plate and the linear expansion coefficient of the base substrate are as close as possible, in consideration of temperature changes caused by, for instance, heating. More specifically, it is desirable that the difference between the foregoing linear expansion coefficients is not more than 2. Furthermore, although it has been stated that the combining layer, top plate, and base substrate are made of materials such as Au and SiO₂, any other materials may be included on condition that the above-described materials are included as major components.

As the ink jetting-out method of the present invention, a method other than the ink pressure method, such as a piezoelectric driving method, a bubble jet method, and a field jetting-out method, may be adopted by itself or in conjunction with the ink pressure method. When the ink pressure method is adopted, although the pressure for causing ink to jet out from the micro nozzles is easily controlled, the shape of the nozzle determines the resistance of the ink flow, especially the diameter of the micro nozzle will considerably affect the jetting-out amount. For this reason, the effect of the present invention that the shape accuracy of the nozzles is confirmed influence more conspicuously on the accuracy of pattern formation.

Note that, when, among the above-mentioned methods, the piezoelectric driving method or the bubble jet method is adopted by itself, a vibrator or heating element has to be large in size to a certain degree, in consideration of the flow resistances of the micro nozzles. In this regard, it is necessary to design the shape of the ink flow path accordingly.

As described above, a pattern formation apparatus of the present invention comprises: a substrate including a concave section; a top plate that is combined with a surface of the substrate where the concave section is provided; a combining layer, provided on at least one of the substrate and the top plate, via which the substrate and the top plate are combined with each other, and nozzles formed by melting the combining layer such that the substrate and the top plate are combined with each other, the nozzles jetting out ink such that a pattern is formed.

With the above, after forming the substrate and the top plate, the combining layer which is a part of the substrate or the top plate is molten so that the substrate is combined with the top plate. On this account, the substrate and the top plate are directly combined with each other with almost no change in shape. As such, it is possible to confirm the shape accuracy of the nozzle opening sections of the nozzles of the pattern forming apparatus, so as to realize a pattern formation with high accuracy. When a wiring pattern of a liquid crystal display apparatus is formed by this pattern formation apparatus, it is possible to form a minute pattern (i) having uniform wiring width and wiring thickness, and (ii) having a coequal wiring resistance, because the respective nozzles have coequal jetting-out amount. On this account, when a color filter is manufactured with the use of the above pattern formation apparatus, the color missing or other problem does not occur. As such, it is possible to form a pattern having a small color heterogeneity.

The pattern formation apparatus of the present invention may be arranged such that the combining layer is made mainly of metal or silicon dioxide (SiO₂).

A thin film can be easily formed with metal or silicon dioxide and the film can be appropriately molten by heating. Thus these materials are suitable for forming the combining layer. On this account, for instance, a combining layer made of such a material is formed on a hard-to-melt substrate or top plate and the substrate and the top plate are superposed to each other and put in a high-temperature atmosphere, so that the substrate and the top plate are easily combined with each other, as only the combining layer is molten. Note that it is preferable that silicon dioxide is an application-type one.

The pattern formation apparatus of the present invention may be arranged such that at least one of the substrate and the top plate is made mainly of silicon, glass, or aluminum oxide (Al₂O₃).

Adopting the substrate or the top plate which is made mainly of silicon, glass, or aluminum oxide, it is possible to form a pattern formation apparatus with minute shape change due to environmental changes but having sufficient rigidity. The combining layer is formed on the substrate or the top plate. Being alternative to this, the following may be carried out: the surface of the substrate or the top plate is molten by the projection of laser light or ion beam, and the molten surface is used as a combining layer. In this case, it is unnecessary to provide an independent process of forming a combining layer, thereby the manufacturing being simplified. Furthermore, since a combining layer is not formed on the substrate or the top plate, the accuracy of the nozzle formation further improves. Note that, in this case a glass used as a material preferably has a lower melting point.

The pattern formation apparatus of the present invention is arranged such that the substrate and the top plate include surfaces to be combined with each other whose relative roughness is not more than 0.1.

A relative roughness indicates the degree of the roughness of a surface. The maximum surface roughness of those surfaces is not more than 0.1 so that the substrate and the top plate are suitably combined with each other, the sufficient rigidity of the pattern forming apparatus is ensured, and the accuracy of the nozzle formation further improves.

The pattern formation apparatus of the present invention is arranged such that each of the nozzles has an opening section from which the ink is jetted out, and the opening section has an area of not more than 50 μm².

In the pattern forming apparatus in which the opening section of the nozzle, from which the ink is jetted out, has an area of not more than 50 μm², it is necessary to form the nozzle with high accuracy, because slight deviation in the nozzle accuracy greatly influences on the pattern formation the effect of the present invention that the shape accuracy of the nozzles is confirmed especially comes into play in a pattern forming apparatus in which the opening section of the nozzle, from which the ink is jetted out, has an area of not more than 50 μm². The effect is further enhanced when the opening section has an area of not more than 10 μm², and much further enhanced when the opening section has an area of not more than 5 μm².

A method of the present invention, which is for manufacturing a pattern formation apparatus, comprises the steps of: (i) combining a surface of a substrate where a concave section is provided with a top plate such that nozzles for jetting out ink are formed; and (ii) melting a combining layer, provided on at least one of the substrate and the top plate, such that the substrate and the top plate are combined with each other via the molten combining layer.

With this, the shape accuracy of the nozzle opening sections of the nozzles is confirmed so that the pattern formation can be done with high precision.

The method of the present invention further comprises the step of: (iii) forming the combining layer.

This makes it possible to form, between the substrate and the top plate, a combining layer which is made of a material different from those of the substrate and the top plate and excels in fusibility and adhesion properties. Thus the substrate and the top plate are easily combined with each other by melting the combining layer by carrying out heating in appropriate conditions. On this occasion, even if the substrate and the top plate are heated altogether, only the combining layer is molten. Note that the formation of the combining layer may be carried out after forming the concave section on the substrate. Alternatively, the concave section may be formed after forming the combining layer.

The method of the present invention may be arranged such that the combining layer includes a first combining layer made mainly of gold and a second combining layer made mainly of gold, aluminum, or tin.

When the combining layer is made of metal, gold is particularly easily molten and thus suitable for the material of the combining layer. For this reason, it is preferable that the combining layer is made mainly of gold. Aluminum and tin are also molten relatively easily so that good combining is ensured when one combining layer is made mainly of gold while the other combining layer is made mainly of aluminum or tin.

The method of the present invention is arranged such that, in the step (ii), the combining layer is molten by applying supersonic waves to at least one of the substrate and the top plate, concurrently with heating.

In this manner, the application of supersonic waves to at least one of the substrate and the top plate precipitates the melting of the surface of the substrate or the top plate, thereby further facilitating the combination of the substrate and the top plate.

The method of the present invention may be arranged such that the combining layer is made mainly of silicon dioxide.

This facilitates the combining, as silicon dioxide is easily molten and excels in adhesion properties.

The method of the present invention is arranged such that the combining layer is formed on the top plate, such that the substrate and the top plate are combined with each other via the combining layer.

Since silicon dioxide particularly excels in adhesion properties, the combining is properly carried out even if the combining layer is formed only on the top plate. This makes it possible to carry out the combining without melting the surface of the substrate, so that the nozzles of the pattern forming apparatus are manufactured with improved accuracy.

The method of the present invention is arranged such that, in the step (ii), the substrate and the top plate are pressed against each other and the combining layer is molten by heat.

In this manner, since the substrate and the top plate are pressed against each other and the combining layer is molten by heat, the substrate and the top plate are suitably combined with each other at the molten combining layer.

The method of the present invention is arranged such that, in the step (ii), the top plate is superposed on the substrate, and from a top plate side, laser light is projected to a space between grooves of the concave section of the substrate.

As the substrate with the concave section is superposed to the top surface and laser light is projected to the combining layer, only the combining surface is heated so that the combining is carried out with no influence on the substrate and the top plate. Furthermore, from the top plate side, laser light is projected to a space between grooves of the concave section of the substrate, so that the combining is suitably carried out with no change in the shape of the nozzle section.

The method of the present invention is arranged such that, the top plate is a low-melting glass.

When the top plate is a low-melting glass, the surface on the combining side of the top plate is molten with the projection of laser light so that the substrate and the top plate are suitably combined with each other without deteriorating the shape of the nozzles.

The method of the present invention is arranged such that, in the step (ii), argon ion beam is projected to the combining layer and the substrate and the top plate are pressed against each other.

In this manner, argon ion beam is projected to the combining surfaces of the substrate and the top plate so that the combining surfaces are activated. The substrate and the top plate being activated are pressed against each other so that these members are suitably combined with each other.

The method of the present invention is arranged such that at least one of the substrate and the top plate is made mainly of silicon, silicon dioxide, or aluminum oxide.

According to this, since at least one of the substrate and the top plate is made mainly of silicon, silicon dioxide, or aluminum oxide, the combining surface is suitably molten with the projection of argon ion beam, so that the substrate and the top plate are combined with each other.

The method of the present invention is arranged such that, on at least one of the substrate and the top plate, a metal thin film is formed, via which the substrate and the top plate are combined with each other.

In this manner, since a metal thin film is formed on the combining surface of at least one of the substrate and the top plate, the combining surface is solid-phase-bonded (eutectic-bonded, diffusion bonded) by the projection of argon ion beam. Thanks to this, the combining can be realized with a low temperature and with minute deterioration of the nozzle shape. On this account, the substrate and the top plate are suitably combined with each other.

The method of the present invention is arranged such that, each of the nozzles has an opening section from which the ink is jetted out, and the opening section has an area of not more than 50 μm².

In the pattern forming apparatus in which the opening section of the nozzle, from which the ink is jetted out, has an area of not more than 50 μm², it is necessary to form the nozzle with high accuracy, because slight deviation in the nozzle accuracy greatly influences on the pattern formation the effect of the present invention that the shape accuracy of the nozzles is confirmed especially comes into play in a pattern forming apparatus in which the opening section of the nozzle, from which the ink is jetted out, has an area of not more than 50 μm².

The present invention may be arranged in the following manner.

A first minute dot forming apparatus, in which an area of a nozzle section that jets out ink and is formed between a concave section formed on a surface of a base substrate and a top plate combined with that surface is not more than 50 μm², is arranged such that a combining surface between the base substrate and the top plate does not have an adhesive agent thereon.

A second minute dot forming apparatus is arranged such that, in addition to the arrangement of the first minute dot forming apparatus, the base substrate and the top plate are a silicon substrate, a glass, SiO₂, or Al₂O₃.

A minute dot forming apparatus is arranged such that, in addition to the arrangements of the first and second minute dot forming apparatuses, the substrate and the top plate include surfaces to be combined with each other whose maximum surface relative roughness Rmax is suppressed to be not more than 0.1.

A method for manufacturing a first minute dot forming apparatus, in which an area of a nozzle section that jets out ink and is formed between a concave section formed on a surface of a base substrate and a top plate combined with that surface is not more than 50 μm², includes the steps of: forming the concave section on the base substrate; forming (i) an Au metal thin film on at least one combining surface of the base substrate and the top plate and (ii) an Au/Al/Sn metal thin film on the other combining surface; and carrying out heat combining, with the base substrate and the top plate having the metal thin film(s) being aligned and pressed against each other.

The method of forming the first minute dot forming apparatus is arranged such that ultrasonic wave is applied on the occasion of carrying out the heat combining.

A method for manufacturing a second minute dot forming apparatus, in which an area of a nozzle section that jets out ink and is formed between a concave section formed on a surface of a base substrate and a top plate combined with that surface is not more than 50 μm², includes the steps of: forming the concave section on the base substrate; forming an application-type SiO₂ on that surface or the top plate; and baking and combining the base substrate and the top plate with each other, at least one of the base substrate and the top plate having the application-type SiO₂, on condition that the base substrate and the top plate are aligned with each other and pressed against each other.

The method of manufacturing the second minute dot forming apparatus is arranged such that the application-type SiO₂ is formed only on the top plate.

A method for manufacturing a minute dot forming apparatus, in which an area of a nozzle section that jets out ink and is formed between a concave section formed on a surface of a base substrate and a top plate combined with that surface is not more than 50 μm², includes the steps of: forming the concave section on the base substrate; aligning a top plate which is a low-melting-point glass with the base substrate; and melting and combining, with the exception of the concave section, the base substrate with the top plate, by projecting laser light from the top plate side.

A method for manufacturing a third minute dot forming apparatus, in which an area of a nozzle section that jets out ink and is formed between a concave section formed on a surface of a base substrate and a top plate combined with that surface is not more than 50 μm², includes the steps of: forming the concave section made of a silicon substrate, SiO₂, or Al₂O₃ on the base substrate; projecting argon ion beam to respective combining surfaces of the base substrate and a top plate made of a silicon substrate, SiO₂, or Al₂O₃; and combining the base substrate with the top plate by causing the base substrate and the top plate made to be aligned with each other and pressed against each other, immediately after the projection of the ion beam.

The method for manufacturing the third minute dot forming apparatus is arranged such that a metal film is formed on a combining surface of at least one of the base substrate and the top plate.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

What is claimed is:

1. A pattern formation apparatus, comprising:
a substrate including a concave section;
a top plate that is combined with a surface of the substrate where the concave section is provided;
a combining layer, provided on at least one of the substrate and the top plate, via which the substrate and the top plate are combined with each other, and
nozzles formed by melting the combining layer such that the substrate and the top plate are combined with each other, the nozzles jetting out ink such that a pattern is formed.

2. The pattern formation apparatus as set forth in claim 1, wherein the combining layer is made mainly of metal or silicon dioxide.

3. The pattern formation apparatus as set forth in claim 1, wherein at least one of the substrate and the top plate is made mainly of silicon, glass, or aluminum oxide.

4. The pattern formation apparatus as set forth in claim 1, wherein the substrate and the top plate include surfaces to be combined with each other whose relative roughness is not more than 0.1.

5. The pattern formation apparatus as set forth in claim 1, wherein each of the nozzles has an opening section from which the ink is jetted out, and the opening section has an area of not more than 50 μm².

6. A method for manufacturing a pattern formation apparatus, comprising the steps of:
(i) combining a surface of a substrate where a concave section is provided with a top plate such that nozzles for jetting out ink are formed; and
(ii) melting a combining layer, provided on at least one of the substrate and the top plate, such that the substrate and the top plate are combined with each other via the molten combining layer.

7. The method as set forth in claim 6, further comprising the step of:
(iii) forming the combining layer.

8. The method as set forth in claim 7, wherein, the combining layer includes a first combining layer made mainly of gold and a second combining layer made mainly of gold, aluminum, or tin.

9. The method as set forth in claim 6, wherein, in the step (ii), the combining layer is molten by applying supersonic waves to at least one of the substrate and the top plate, concurrently with heating.

10. The method as set forth in claim 7, wherein the combining layer is made mainly of silicon dioxide.

11. The method as set forth in claim 10, wherein, the combining layer is formed on the top plate, such that the substrate and the top plate are combined with each other via the combining layer.

12. The method as set forth in claim 6, wherein, in the step (ii), the substrate and the top plate are pressed against each other and the combining layer is molten by heat.

13. The method as set forth in claim 6, wherein, in the step (ii), the top plate is superposed on the substrate, and from a top plate side, laser light is projected to a space between grooves of the concave section of the substrate.

14. The method as set forth in claim 13, wherein, the top plate is a low-melting glass.

15. The method as set forth in claim 6, wherein, in the step (ii), argon ion beam is projected to the combining layer, and the substrate and the top plate are pressed against each other.

16. The method as set forth in claim 15, wherein, at least one of the substrate and the top plate is made mainly of silicon, silicon dioxide, or aluminum oxide.

17. The method as set forth in claim 15, wherein, on at least one of the substrate and the top plate, a metal thin film is formed, via which the substrate and the top plate are combined with each other.

18. The method as set forth in claim 6, wherein each of the nozzles has an opening section from which the ink is jetted out, and the opening section has an area of not more than 50 μm².
